(19) United States
(12) Patent Application Publication
(10) Pub. No.: US 2009/0037467 A1
(43) Pub. Date: Feb. 5, 2009

(54) MEDIA MANAGEMENT, PRODUCTION, AND DELIVERY SYSTEM AND METHOD

(76) Inventor: Fu-Sheng CHIU, Taipei City (TW)

Correspondence Address: SINORICA, LLC, 528 FALLSGROVE DRIVE, ROCKVILLE, MD, 20850, US

(21) Appl. No.: 11/835,664

(22) Filed: Aug. 8, 2007

(30) Foreign Application Priority Data
Jul. 31, 2007 (TW) 096127909

(51) Int. Cl. G06F 3/00; G06F 17/30

(52) U.S. Cl. 707/104.1; 715/716; 707/E17.01

(57) ABSTRACT

A media management, production, and delivery system and method for providing an efficient means of producing and delivering text and media are disclosed. Original text such as a news story is provided by a media source. Media relevant to the original text is edited and linked to the text. The edited and linked media and text is published to a television station, television, web site, and mobile device. Users select a news story and can read the text article while the media plays in a media player window. The original and edited versions of the text and media are stored in a media archive and available for future use. The timing of publishing media is selectable so that a media playlist can be created for broadcasting.

### BACKGROUND OF THE INVENTION

1. Field of the Invention

The present invention relates to media production systems. More specifically, the present invention discloses a media system that provides an efficient means of managing, producing, and delivering linked text and media and a method for utilizing the system.

2. Description of the Prior Art

In the past news reporters had to manually search through databases containing news reports in order to obtain background information or other information they needed in order to complete their report. This was also the case with television news reporting. This method was not only time consuming but important information was often overlooked or not located. As a result, important news information went unreported or under-reported.

Various newswire agencies provide news articles to publishers who in turn print or broadcast the news. However, the news is supplied in text only format which is limiting. People today are interested in receiving news in a variety of formats not only print.

In order to improve the efficiency and quality of news reporting Associated Press developed a news production system named ENPS (electronic news production system). ENPS allows users to easily access news items and articles by providing a search engine for finding the news items anywhere in the system. As news items are published or broadcast over the wire the articles are included in the news archive and made available to users.

When a reporter searches for information a list of search results is presented and the reporter can access articles of interest. Additionally, as new items cross the wire reporters can easily see breaking stories and view abstracts of the news story.

However, while conventional news production systems are very useful for locating news items the systems are typically limited to text only files.

Additionally, conventional news delivery systems only provide the news in a single format. This method is inflexible as users cannot determine which delivery method in which to receive the news.

Therefore there is need for a news media production system and method that manages media in a variety of formats and delivers news to a variety of devices.

### SUMMARY OF THE INVENTION

To achieve these and other advantages and in order to overcome the disadvantages of the conventional method in accordance with the purpose of the invention as embodied and broadly described herein, the present invention provides a media management, production, and delivery system and method for providing an efficient means of producing and delivering text and media. Original text such as a news story is provided by a media source. Media relevant to the original text is edited and linked to the text. The edited and linked media and text is published to a television station, television, web site, and mobile device. Users select a news story and can read the text article while the media plays in a media player window. The original and edited versions of the text and media are stored in a media archive and available for future use. The timing of publishing media is selectable so that a media playlist can be created for broadcasting.

In the present invention media such as video clips, audio clips, music, movies, and photos are stored on the media database server. As news reports cross the wire the text is stored in a news database on the media database server and is accessible by the editing system. An editor using the editing system connects or links media relevant to the news report to the text of the report. The editing system also allows the editor to edit the media, crop pictures, and preview the media. After editing, the publishing system publishes the media in a plurality of formats. For example, the media is broadcast on television, broadcast to mobile devices such as cellular telephones, or published on a web site. The edited media is also archived on the media archive server and made available to users for future access and use. When a user accesses the media text, for example, a news article is viewed along with media associated with the news article.

The present invention also provides a method for utilizing the media management, production, and delivery system. The method comprises editing original text which has been provided by a media source. Additionally, original media relevant to the text is edited and linked to the text. The linked edited media and text are then published to a variety of devices in their corresponding format.

The present invention also provides a method of delivering news via a website. The news website comprises a story content list with a plurality of different sizes of images linked to media. Different sizes of images are displayed. Breaking news or top stories are highlighted by making the image larger and at the top of the story content list. Minor stories are given smaller images lower on the page.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing illustrating a news media management, production, and delivery system according to an embodiment of the present invention;

FIG. 2 is a drawing illustrating a news media management, production, and delivery system according to an embodiment of the present invention;

FIG. 3 is a drawing illustrating a news media management and delivery system according to an embodiment of the present invention; and

FIGS. 4A and 4B are drawings illustrating a webpage layout of a news website according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

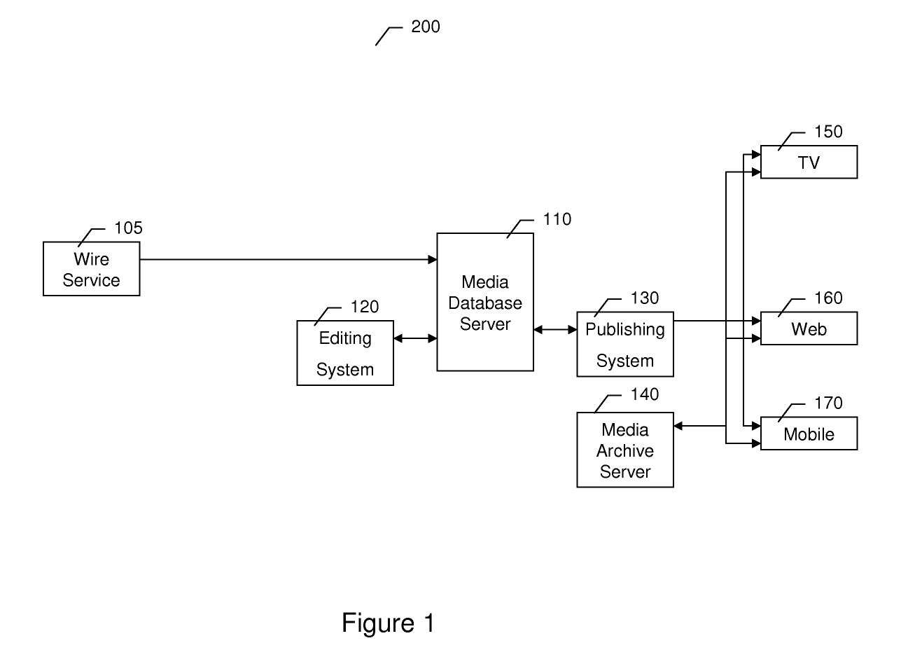

Refer to FIG. 1, which is a drawing illustrating a news media management, production, and delivery system according to an embodiment of the present invention.

As shown in FIG. 1, the news media management, production, and delivery system comprises a media database server 110, a wire service 105, an editing system 120, a publishing system 130, and a media archive server 140.

Media such as video clips, audio clips, music, movies, and photos are stored on the media database server 110. As news reports cross the wire the text is stored in a news database on the media database server 110 and is accessible by the editing system 120. An editor using the editing system 120 connects or links media relevant to the news report to the text of the report. The editing system 120 also allows the editor to edit the media, crop pictures, and preview the media. After editing, the publishing system 130 publishes the media in a plurality of formats. For example, the media is broadcast on television 150, broadcast to mobile devices 170 such as cellular telephones, or published on a web site 160. The edited media is also archived on the media archive server 140 and made available to users for future access and use.

When a user accesses the media text, for example, a news article is viewed along with media associated with the news article. For example, a text news article about a war also includes on the ground video footage relevant to the text news article.

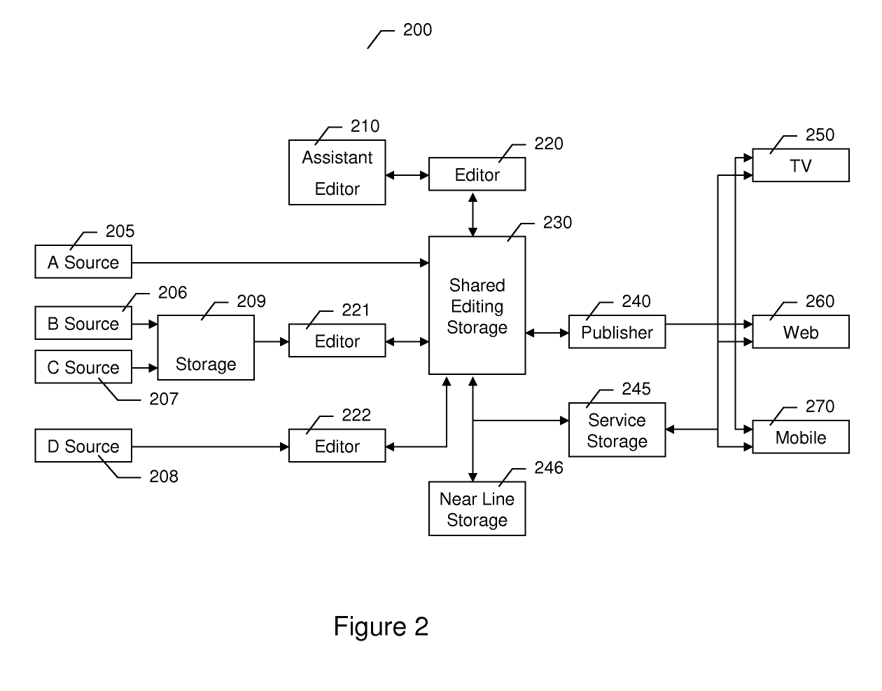

Refer to FIG. 2, which is a drawing illustrating a news media management, production, and delivery system according to an embodiment of the present invention.

As shown in FIG. 2, the news media management, production, and delivery system 200 comprises an A source 205, a B source 206, a C source 207, and a D source 208 which provide media and text data. The A source 205 provides a live video stream, for example from a television channel. The live video stream is recorded and stored on a shared editing storage server 230. The B source 206 and the C source 207 provide media such as video clips, movies, audio, music, photos, and text. The B source 206 and C source 207 are websites where users upload media which is then stored on a storage server 209. The D source 208 comprises a cooperative media source, for example, a news wire service such as Reuters or the Associated Press.

An editor or editors 220, 221, 222 select the media or text material and convert the files. The media is automatically converted when selected. Preliminary manuscript revising and sorting is performed and the media or text is edited. The editors 220, 221, 222 also select a layout, for example, a web page layout or style for the media and text to be displayed in. The edited or modified material is then submitted and stored on the shared editing storage server 230. The shared editing storage server stores text, pictures, video clips, audio clips, music, and movies.

An assistant editor 210 removes advertisements or commercials from the media or text and combines each segment of a program. The assistant editor 210 also sorts the media according to a manuscript or text and delivers the edited media to the editor 220.

When text only material is provided by a source, for example, a wire service, the editor 220, 221, 222 or assistant editor 210 select the text and search a media database for media relevant to the text or article. The relevant media is linked to text so that they can be utilized together.

A publisher 240 reviews material which the editors 220, 221, 222 have edited and submitted to the shared editing storage server 230. The publisher 240 also reviews the layout of the media or text. If acceptable, the publisher 240 publishes the media to a television station 250 for broadcast, to a website or websites 260, and to a mobile device or service 270. In this way the media is enjoyed by television viewers, Internet users, and mobile device users.

Edited and published material is stored on a service storage server 245 and is available for use or sale. Users or subscribers can use or purchase the media or material stored on the service storage server 245. The media is stored in a variety of formats so that users of different devices can access the media according to their needs.

The edited and original media or material is automatically stored in a database or archive on a near line storage server 246. The archive is searchable so that the material can be used in the future.

In an embodiment of the present invention the editors 220, 221, 222 are the same person. In another embodiment they are different people.

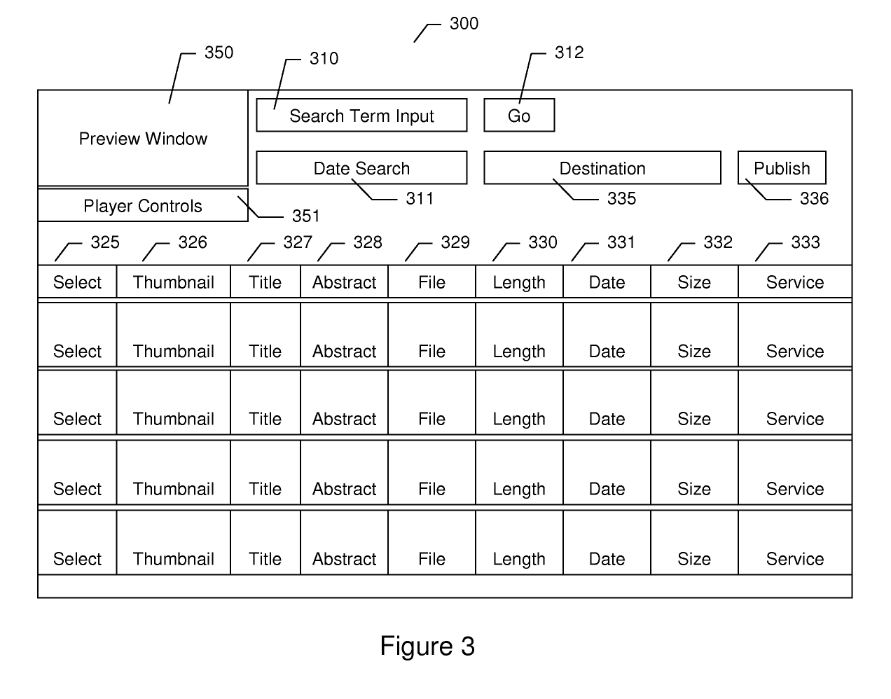

Refer to FIG. 3, which is a drawing illustrating a news media management and delivery system according to an embodiment of the present invention.

In order to efficiently manage and deliver the edited material the present invention provides a media management screen 300. In this screen 300 or window an editor or publisher searches for media using a search term box 310 or a date search box 311 or menu. After the date, date interval, or search term have been selected and the search button 312 is clicked, a results list is provided comprising a list of media associated with the date or search term.

An editor or publisher selects the media to publish by selecting a select box 325 next to a thumbnail 326 of the media. The title and text abstract of the media is displayed in a title area 327 and abstract area 328 respectively. The abstract is a summary of the contents of the media or an abstract of text associated with the media. The file name 329, media duration 330, creation date 331, and size 332 are also displayed. As well, the type of service is displayed in a service box 333.

A media preview window 350 with player controls 351 are provided to allow the media to be previewed before publishing.

The media management screen 300 also provides a publish destination input box 335 for inputting or selecting a location or locations where the media is to be broadcast or published to and a publish go button 336 to execute the publishing. For example, a television station, Internet website, and a mobile service can be selected and the media in the correct format is published or broadcast to each one.

The publishing or broadcast order is determined or changed by dragging a media clip into a new location ahead of or after another piece of media on the media management screen 300. Additionally, a publishing timeline allows users to create a media playlist for scheduled broadcast.

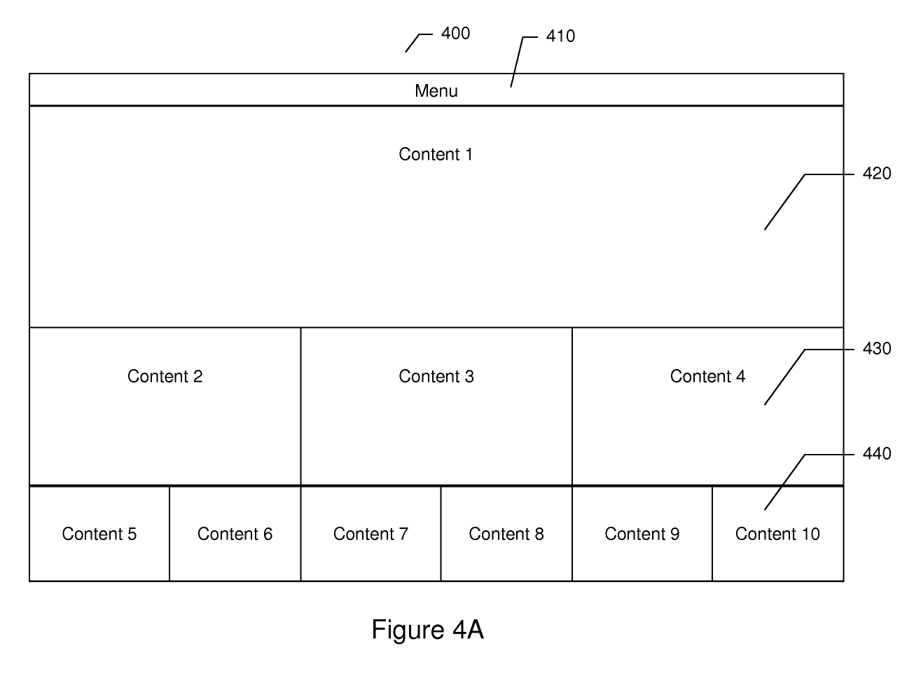

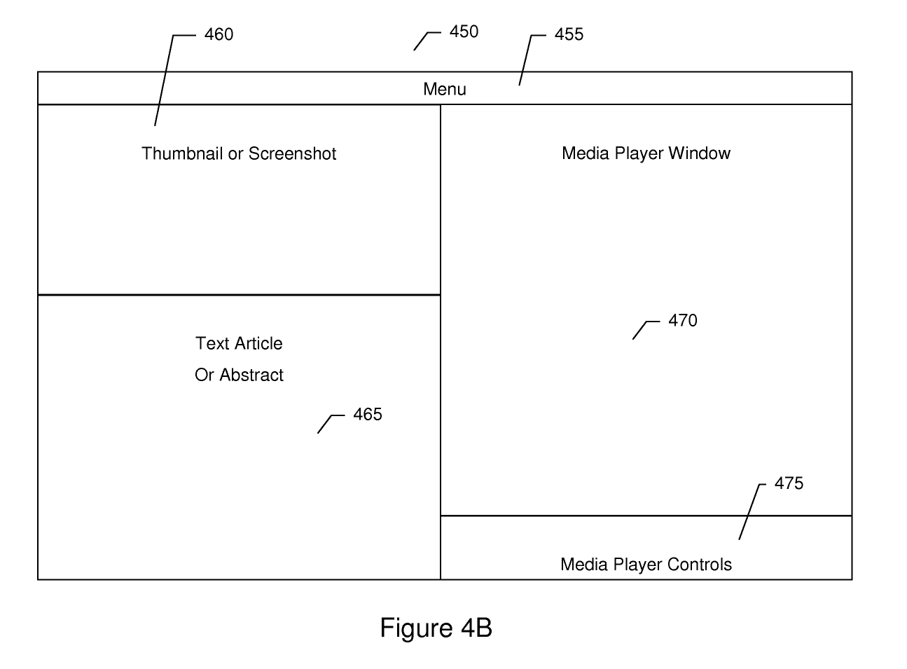

Refer to FIGS. 4A and 4B, which are drawings illustrating a webpage layout of a news website according to an embodiment of the present invention.

In embodiments of the present invention the media is published to a news website. Prior to publishing the media, an editor or publisher selects the layout for the webpage.

In the embodiment illustrated in FIGS. 4A and 4B, the webpage comprises a story content list with a plurality of different sizes of images linked to media. In FIG. 4A the different sizes of images are shown as content 1 420 being the largest sized image, content 2-4 430 as smaller images and content 5-10 440 as the smallest images. In this way, breaking news or top stories are highlighted by making the image larger and at the top of the story content list. Minor stories are given smaller images lower on the page.

In the embodiment illustrated in FIG. 4A ten items are shown. In other embodiments of the present invention the story list is scrollable and a large number of images for content are available.

The webpage also comprises a menu 410 for navigating to different categories of news, for example, regional, national, local, international, sports, and entertainment. Each main category comprises multiple subcategories to narrow the category, for example, under the main category Sports, subcategories Baseball, Football, and Baseball are provided.

Each image is linked to a specific media file and when clicked a thumbnail 460 and text abstract 465 or text article of the media associated with the image is displayed. A user can read the abstract 465 or the complete text of the news article as the media is displayed or played in a media player window 470. The media is controlled by media player controls 475 located next to the media player window 470.

Options are also provided to change the media player window's size. For example, the media player window can be set to full screen to increase enjoyment.

In an embodiment of the present invention the media player window is detachable from the main window. In this way, the media can be viewed on top of other applications while the user performs other tasks. For example, the media is enjoyed while the user is working on a text document.

In another embodiment of the present invention the browser is minimized so that only the media player window is visible.

In another embodiment of the present invention when a user selects media the media window is displayed and the text article scrolls in the media player window or next to the media player window.

In another embodiment of the present invention an advertising window is provided along with the media player window. In this way users can enjoy the media without interruption from advertising while advertisers can have marketing opportunity. Users can view advertising if they wish and aren't annoyed by advertising interruptions.

When the editor or publisher determines where on the page layout the news story will appear, the correct image size will be published to the website and the webpage is updated. In this way, the website content and layout is easily managed. For example, the publisher can easily change the layout to move a news story up or down the story content list.

Templates are provided for page layouts to increase efficiency. An editor simply selects a template and where to display the stories in the layout. Since all pictures are cropped for all sizes the layout is very flexible. For example, all levels in the story content list can have different layouts.

The present invention provides integrated text, pictures, video, and audio so that users can utilize the news service in various formats thereby ensuring an improved user experience.

In an embodiment of the present invention the news is streamed to users as a webcast or Internet television. A user can switch between categories of news and the media is streamed to the user similar to television. In this way, the user does not need to continually select news items and can simply enjoy a continuous stream of news media. Additionally, a user can select breaking news or top news media and the media will stream similar to a television news broadcast.

In an embodiment of the present invention, users or media sources can provide media content in various formats. The original media is transcoded to a high resolution version for archive and television, a low resolution for editing, a web resolution for Internet use, and a mobile device resolution. The editor uses the low resolution version during editing and the edit decision list EDL is used to edit the high resolution version.

In an embodiment of the present invention a scrolling banner or ticker-tape style window is provided in which the latest news stories are displayed.

In an embodiment of the present invention a plurality of media is associated or linked to a news item. For example, when a user selects a news item a stream of media is played one after the other.

In an embodiment of the present invention the text associated with the media is sent to a television station and displayed on a teleprompter for the announcer to read while the media is played.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A media management, production, and delivery system comprising:
a media source for providing original media;
a wire service for providing original text;
a media database server for storing the original media and the original text;
an editing system for editing the original media and the original text and for linking relevant media to relevant text; and
a publishing system for publishing edited media and edited text.

2. The media management, production, and delivery system of claim 1, further comprising:
a media archive server for storing the edited media and edited text.

3. The media management, production, and delivery system of claim 1, the media source comprising a newswire service.

4. The media management, production, and delivery system of claim 1, the publishing system publishing the edited media and edited text to a television station, a television, a mobile device, a wireless mobile device, a network, a computer, an Internet, or a combination of these.

5. The media management, production, and delivery system of claim 1, further comprising:
a second media source for supplying user media for the editing system to utilize.

6. The media management, production, and delivery system of claim 1, where the original text is a news story.

7. The media management, production, and delivery system of claim 1, where the original media is uploaded by a private individual.

8. The media management, production, and delivery system of claim 1, where the original media, the original text, the edited media, and the edited text are searchable.

9. The media management, production, and delivery system of claim 1, where a plurality of media files are associated with a single text file.

10. A method for managing, producing, and delivering news comprising:
editing original text provided by a media source;
editing original media relevant to the original text;
linking edited media and edited text; and
publishing linked edited media and edited text.

11. The method for managing, producing, and delivering news of claim 10, where the linked edited media and edited text are published to a television station, a television, a mobile device, a wireless mobile device, a network, a computer, an Internet, or a combination of these.

12. The method for managing, producing, and delivering news of claim 10, where the media source is a newswire service.

13. The method for managing, producing, and delivering news of claim 10, where the original media is uploaded by a private individual.

14. The method for managing, producing, and delivering news of claim 10, further comprising:
storing the linked edited media and edited text.

15. A method for delivering news media comprising:
providing a story content list comprising images associated with news stories;
providing a media player window for displaying media when a user selects an image in the story content list; and
providing a text window for displaying the news story associated with the media.

16. The method for delivering news media of claim 15, further comprising:
providing a menu for navigating to different categories of news.

17. The method for delivering news media of claim 15, where top news stories have larger images than other news stories.

18. The method for delivering news media of claim 15, further comprising:
providing an option to change size of the media player window.

19. The method for delivering news media of claim 15, further comprising:
providing an automatically scrolling window displaying breaking news stories.

20. The method for delivering news media of claim 15, further comprising:
providing an option to continuously stream the media to a user.
